(19) United States
(12) Patent Application Publication
(10) Pub. No.: US 2004/0174244 A1
(43) Pub. Date: Sep. 9, 2004

(54) RFID smart reader switch control system

(75) Inventor: Patrick Eidemiller, La Canada, CA (US)

Correspondence Address: Pillsbury Winthrop LLP, Intellectual Property Group, Suite 2800, 725 South Figueroa Street, Los Angeles, CA, 90017-5406, US

(73) Assignee: SDI INDUSTRIES, INC., Pacoima, CA

(21) Appl. No.: 10/384,337

(22) Filed: Mar. 7, 2003

(51) Int. Cl. H04Q 1/00

(52) U.S. Cl. 340/5.61

(57) ABSTRACT

A Smart Reader for controlling a switching station has several elements. First, it includes an interrogator for communicating with an RFID transponder, the RFID transponder having a specific code stored on a memory chip therein. A memory module is electronically coupled to the interrogator and is configured to store at least one code transmitted by the RFID transponder to the interrogator. Circuitry for comparing an input from the interrogator and the at least one code stored in the memory module is coupled to at least one relay. The at least one relay is electronically coupled to a physical switching station, and controls the physical switching station based at least in part on the specific code stored in the RFID transponder.

### FIELD OF INVENTION

The present invention is directed generally to a device for controlling a switching system on a movable conveyance system, and more specifically to a radio frequency identification (RFID) interrogator and control module to control a switching system based in part on a signal from a transponder.

### BACKGROUND

Wholesalers of goods and products, such as Liz Claiborne, generally transport their merchandise from a manufacturing facility to a distribution warehouse. At the distribution warehouse, the merchandise is separated and sorted according to the inventory needs of individual store locations. Movable conveyance systems such as conveyor belts and overhead hanging garment conveyance systems are often utilized to efficiently move product through the distribution warehouse and sort the product according to a company's prescribed needs. The merchandise is generally grouped in a systematic fashion (for example, all the merchandise being transported to a particular store is grouped together) and then placed on a trolley or inside some other carrier like a bin or barrel before being inducted into the movable conveyance system. The system transports those carriers to a fixed location in the warehouse where they await loading onto a truck for transportation to their individual store destinations.

Such article sorting systems are generally well known in the art. There are many examples of sorting systems for specific types of articles. For example, U.S. Pat. Nos. 3,884,370 and 4,106,636 disclose systems for sorting letters and other flat articles. U.S. Pat. No. 5,072,822 discloses a system for sorting garments using bar codes. However, these systems generally require centralized programmable logic controllers (PLC's), or microprocessor control systems to control and direct the flow of product through the distribution warehouse. The requirement of a centralized control center increases the product cost of the conveyance systems and increases the amount of human labor required to run the system. Additionally, the prior art does not generally allow for the flexibility that a non-centralized system can accommodate.

In the prior art, the use of Radio Frequency Identification (RFID) systems have been commercially used to track merchandise and as theft prevention systems. Such RFID systems include a transponder (generally attached to the merchandise) and an interrogator that can receive radio signals from the transponder and interpret the signals into digital data. From there, the data can be sent to a central database for tracking of products or a signal can be sent to an auditory signal generating device in the case of theft prevention. However, heretofore, RFID systems have not been used to route products along movable conveyor systems. One reason for this is because heretofore, an interrogator has not been combined with intelligent circuitry and relay system to control a physical switching apparatus.

What is needed is an apparatus that can effectively combine an interrogator with intelligent circuitry and relay system that can control a switching station.

### BRIEF DESCRIPTION OF THE DRAWINGS

FIG. 1 is a flowchart diagram describing a method of the present invention;

FIG. 2 shows a block diagram of the components of a Smart Reader according to an embodiment of the present invention.

### DETAILED DESCRIPTION

Embodiments of the present invention are directed to a Smart Reader, a device that integrates an RFID interrogator, intelligent circuitry, and a relay system into a cohesive apparatus. The device is intended to control switching stations on a movable conveyance system in response to a specific code transmitted by a transponder attached to either a product or a carrier transporting merchandise. For operation of the system, a readable RFID transponder is programmed with a code indicating a final destination location in a warehouse or distribution center. The transponder is attached to or embedded in a carrier and inducted into the movable conveyor system. A Smart Reader is located at each switching station where the carrier may need to change tracks. A switching station may be defined as any point along a movable conveyance system wherein an item being transported down a single conduit may be directed down one of at least two different conduits. When the transponder comes within range of the Smart Reader, the interrogator demodulates the signal and ‘reads’ the code programmed in the transponder and transmits the data to the intelligent circuitry. The intelligent circuitry includes a comparator and the incoming data from the interrogator is compared to data retained in a memory module of the Smart Reader. Based at least in part on that comparison, the intelligent circuitry sends a signal to one of several relay components, which control a physical switching station. Depending on the relay that is activated, the switch is either opened or it is ensured the switch is closed. The exemplary application proposed in this description involves the use of radio frequency identification (RFID) chips to direct and route a trolley bearing garments throughout a distribution center that utilizes an overhead hanging garment conveyor system as a movable conveyance system.

The Smart Reader has application across many fields and as such different embodiments may be specifically geared towards transponders that use different frequencies. RFID transponders and interrogators are commonly manufactured to utilize the low frequency (ranging from 3-300 kHz, but typically closer to 125 kHz), high frequency (ranging from 3-30 MHz, but typically closer to 13.56 MHz), and ultra-high frequency (UHF) (ranging from 300-3000 MHz, but typically closer to 850-920 MHz), swaths of the electromagnetic spectrum. Occasionally, frequencies in the microwave spectrum (near 2.45 GHz) are used for some applications. Different frequencies have different characteristics that make them more useful for certain applications. Low frequency transponders are cheaper than UHF transponders, use less power, and are better able to penetrate non-metallic substances. UHF transponders typically offer better range and can transfer data faster, but they use more power, are less likely to pass through material, and require a clear path between the tag and the reader. An embodiment of the present invention may utilize a transponder that works on a frequency near 134.2 kHz, for example.

The present invention may utilize both “read only” RFID transponders and read/write RFID transponders. “Read only” transponders may be programmed with a code at the factory where they are manufactured. These transponders cannot be reprogrammed. Embodiments of the present invention that utilize “read only” transponders require a human operator to correlate a particular code with a particular destination location. That is, “read only” transponders are encoded with a known programmed code, say “6000” for example, that human operators can designate as always travelling to Aisle 6 as a final destination. A particular “read only” transponder will always travel to a certain destination. “Read only” transponders may be purchased in multiples with the same programmed code, so that if a particular “read only” tag breaks, a human operator need only replace the tag with a working tag having the same pre-programmed code.

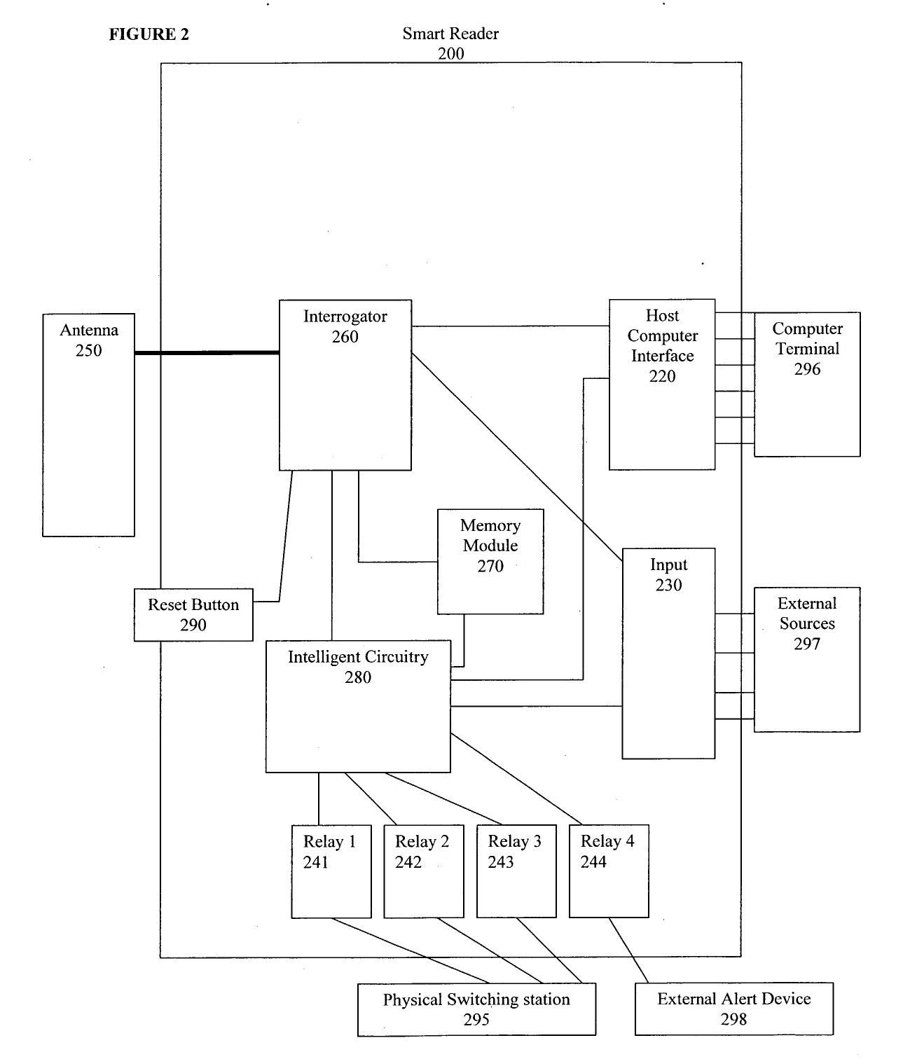

Read/write transponders 200 (See FIG. 2) may be programmed at the location where they will be used, and they may be reprogrammed many times over. If the system is using a read/write RFID transponder, the Smart Reader 200 may also program the transponder with a specific code.

This use of a Smart Reader 200 creates several advantages over previous systems: the system utilizes a lighter, less expensive trolley than that required by mechanical pin reader systems. This system is less expensive than bar code scanner systems. There are no mechanical parts to jam or break in the Smart Reader 200. No centralized control center is necessary for operation of this system, and once the human operator has set the destination into the transponder, the operator can move on to other activities while the carrier is processed. Additionally, because no central control center is necessary, the system is more flexible and cheaper to produce. Because the readers are independent from each other, a carrier may be inducted into the system anywhere, not only at established induction locations.

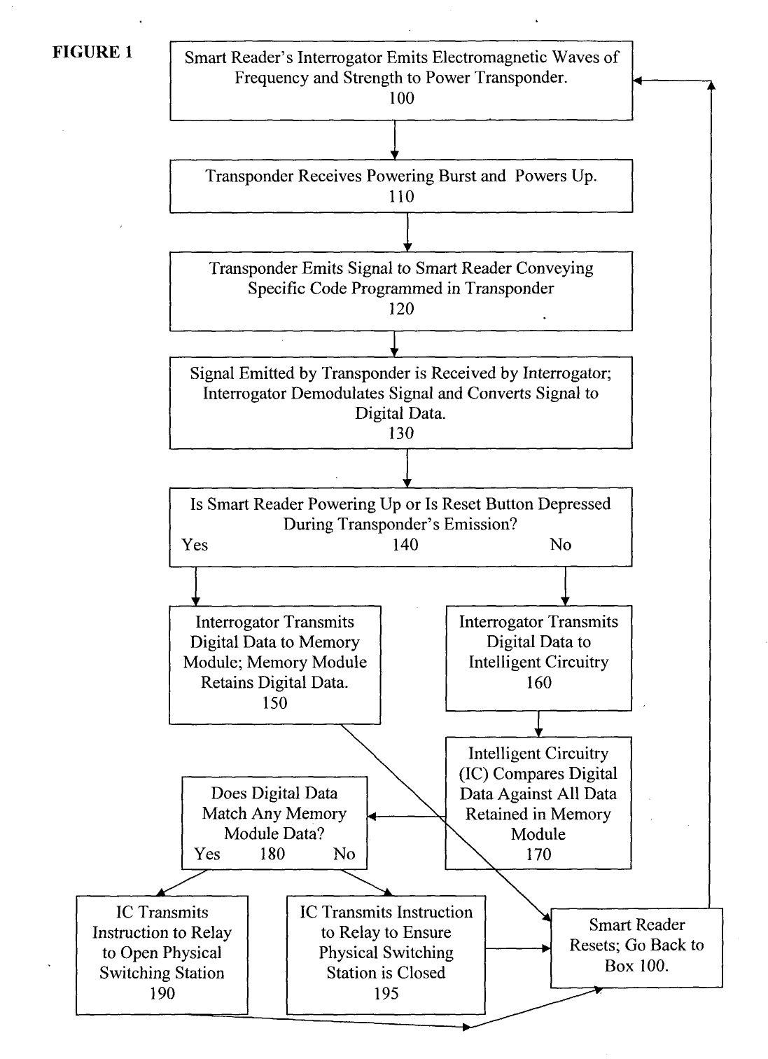

FIG. 1 depicts a flow chart diagram describing a method of operating a Smart Reader according to an embodiment of the present invention. FIG. 2 shows a block diagram of the components of a Smart Reader according to an embodiment of the present invention. According to one embodiment of the invention, the Smart Reader 200 is intended to compliment a passive RFID transponder. A passive transponder lacks any power supply (like a battery) of its own, and so must use the electromagnetic waves emitted by the interrogator 260 to transmit its own signal. Once the Smart Reader 200 has begun powering on, the interrogator 260 may continuously emit the electromagnetic waves capable of powering on the transponder. Examples of interrogators are plentiful as they are commonly produced by such companies as Texas Instruments and Omron. An embodiment of the present invention may use a Texas Instrument Series 2000 Micro Reader, Part No. RI-STU-MRD1 as the interrogator 260 to communicate with a 134.2 kHz, Half Duplex, Frequency Shift Keying (FSK) transponder such as Part No. RI-TRP-DR2B. Additional embodiments may use different interrogators and transponders depending on the desired frequency wished to be employed in the system. Such other embodiments may use interrogators that communicate with passive transponders of different frequencies or active transponders or semi-active transponders. The type of interrogator used is not novel and one skilled in the art may employ any number of interrogators to accomplish the goal of the present invention.

According to an embodiment of the present invention, if it is intended for a switching station 295 to switch tracks in response to a specific code in a transponder, the Smart Reader 200 may be trained to recognize that specific code as part of a one-time set-up process. Training a Smart Reader 200 to recognize a code will mean that the Smart Reader 200 will instruct a switching station 295 to open the switch (meaning, switch to a different track). In an embodiment of the present invention, the Smart Reader 200 may be trained by placing a transponder with the desired code within the “read distance” of the Smart Reader 200 while either the Smart Reader 200 is powering on or the reset button 290 is depressed. The “read distance” is defined as the maximum distance from the Smart Reader 200 in which the antenna 250 will still be able to capture the radio signal given off by the transponder. When the transponder is within the read range of the antenna 250, the interrogator's 260 electromagnetic waves will be transmitted through the antenna 250 to power the transponder. The transponder may then transmit the specific code programmed within its readable chip back to the interrogator 260, through the interrogator's 260 antenna 250. If the Smart Reader 200 is powering on or the reset button 290 is depressed, the memory module 270 will be activated. The interrogator 260 will demodulate the incoming signal from the transponder, extract the code therein, and send the data to the memory module 270 where the memory module 270 will store it until such time as the reset button 290 is depressed again or the Smart Reader 200 is deprived of power for such a time as to drain the memory. In an embodiment of the present invention, a battery is coupled to the memory to prevent accidental memory shutoff. According to one embodiment, the Smart Reader 200 is now trained. The Smart Reader 200 does not need to be connected to a central computer or microprocessor controlled station. Each Smart Reader 200 may be independent of any other Smart Reader 200 in the system. Once the Smart Reader 200 has been trained, it is fully operational.

According to an embodiment of the present invention, the Smart Reader 200 may have a visual alert system, for example a bank of light emitting diodes (LEDs) that alert a human operator to the status of the Smart Reader 200, for example, alerting the operator that the Smart Reader 200 is receiving a transmission from a transponder.

As stated above, according to one embodiment, in a default mode, once powered on, the Smart Reader 200 continuously outputs 100 electromagnetic waves (See FIG. 1). That is, its default is constantly in a “read mode.” As transponders attached to carriers are carried throughout the system, the transponders will encounter Smart Readers 200 at every switching station 295, that is at every location in the system where the carriers to which the transponders are attached may need to change tracks. As the transponder approaches a Smart Reader 200, the transponder is powered 110 up by the electromagnetic waves being transmitted by the interrogator 260, through the antenna 250. The transponder outputs 120 a signal representing the specific code programmed in the readable chip of the transponder to the interrogator 260, through the antenna 250. An embodiment of the present invention may utilize a FSK modulation wherein the transponder receives a signal at a frequency, for example, of 134.2 kHz and then transmits a signal at 123.2 kHz. According to this embodiment, the transponder may be a half-duplex transponder.

The interrogator 260 demodulates 130 the signal and extracts the code contained therein. If the Smart Reader is powering up or if the reset button is depressed 140, the interrogator 260 transmits 150 the data to the memory module 270, as discussed. If the neither the above two criteria are applicable, the interrogator 260 transmits 160 the data to an intelligent circuit 280 for processing. The intelligent circuitry 280 includes a comparator circuit. In an embodiment of the invention, the comparator circuit is a flash microprocessor manufactured by Atmel, part no. AT90S8515. The comparator circuit, in general, accesses the specific codes retained in the memory module 270 during the training process and compares 170 the codes with the new data delivered by the interrogator 260. If the new data matches 180 any of the data retained in the memory module 270, then the intelligent circuit transmits 190 power to relay 1 241. Relay 1 241 transmits a signal to the physical switching station 295 to open the switch. If the new data does not match the data in the memory module 270, then the intelligent circuit transmits 195 power to relay 2 242. Relay 2 242 transmits a signal to the physical switching station 295 to ensure that the switch is closed.

In an embodiment of the present invention, the Smart Reader 200 contains an input interface 230, that receives input from external sources 297. In an embodiment of the present invention, the input interface 230 is capable of receiving four inputs from external sources 297. One such input may be an external trigger to command the interrogator 260 to “read” the transponder when it is not desirable to operate the Smart Reader 200 in a continuous read mode. For example, continuous read mode is not desirable when several transponders are within the read range of the antenna 250. In this case, the external trigger may be used after preparations have been made to isolate a single transponder for reading. Additionally, the external trigger may be used during the “write” application of the Smart Reader 200. The use of an external trigger in this fashion ensures that a transponder is not re-programmed by accident by allowing a human operator to ensure that the correct transponder is in place and that no other transponders are within the write range.

In an embodiment, there may also be an input from an external source 297 that indicates that the lane which the carrier is intended to travel to is full. Such an input may come from a sensor located on or near the conveyance system, some distance down field from the switching station 295 and Smart Reader 200. In this embodiment, the “Lane Full” input may send a signal to Relay 3 243. The relay 243 may then send a signal to the switch 295 not to allow the carrier to travel any further down that path. The switching station 295 may hold the carrier at that location, or the switching station 295 may convey the carrier down another path and recirculate the carrier. In the later embodiment, the carrier will return to the same switching station at another time.

In an embodiment of the invention, although a fourth input may be accommodated in the input interface 230, it is not used. The fourth input is intended to accommodate future functionality.

If the either the transponder or the Smart Reader 200 malfunctions, a fourth relay 244 outputs an error signal to an external alert device 298. The external alert device 298 may be a visual alert, for example, a light emitting diode (LED), or an auditory alert, for example a siren. The external alert device 298 may also be a display on a computer system. One skilled in the art will recognize numerous examples of external alert devices.

In addition to its “read” functions, the Smart Reader 200 may also possesses “write” capabilities. That is, the Smart Reader 200 may be able to write a specific code into a transponder. In an embodiment of the present invention, the Smart Reader 200 also possess a host computer interface 220. The host computer interface 220 allows for several inputs from a computer host 296 or other similar device like a fixed location programmable keypad. It also allows for the output of data to a computer host 296 or similar device. In one embodiment, the host computer interface 220 allows for three inputs (Receive Data or RXD) and three outputs (Transmit Data or TXD). The host computer interface 220 in conjunction with the interrogator 260 allows the Smart Reader 200 to write to the transponder. In an embodiment of the present invention, a computer program installed on the host computer allows for a human operator of the host computer to select a specific code representing a final destination for the transponder. The software may then command the Smart Reader 200 to program that code into the transponder. In so doing, an input from the host computer 296 will enter through the host computer interface 220, and a signal will be sent to the interrogator 260. The interrogator 260 will then send the signal through the antenna 250 to the transponder to program it with the code. The Smart Reader 200 can also send information to the computer 296 through the outputs in the host computer interface 220. Outputs may include such transmissions as an acknowledgement that the transponder was successfully programmed, the value of the code programmed in the transponder, or that there is an error with either the transponder or the Smart Reader 200. The host computer 296 may also transmit to, and receive from, the intelligent circuitry 280, data, via the host computer interface 220.

While the description above refers to a particular embodiment of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the forgoing description, and all changes that come within the meaning and range of equivalency of the claims are therefore intended to be embraced therein.

What is claimed is:

1. A Smart Reader switch control system, comprising:
an interrogator to communicate with an RFID transponder, said RFID transponder having a specific code stored on a memory chip within the RFID transponder;
a memory module electronically coupled to the interrogator to store at least one code transmitted by a transponder to the interrogator;
a circuitry to compare an input from the interrogator and a code stored in the memory module; and
at least one relay module electronically coupled to the circuitry and electronically coupled to a physical switching station.

2. The system of claim 1, wherein the interrogator, the memory module, the circuitry, and the relay module are all housed in a same housing.

3. The system of claim 1, wherein the system operates on a low frequency of approximately 134.2 kHz.

4. The system of claim 1, further including a reset button.

5. The system of claim 1, further including circuitry configured to interface with a computer.

6. The system of claim 1, further including at least one visible indicator to indicate a status of the Smart Reader.

7. The system of claim 6, wherein the at least one visible indicator is a light emitting diode (LED).

8. The system of claim 1, further including circuitry to accept wired input.

9. A Smart Reader switch control system, comprising:
an antenna to communicate with an RFID transponder;
a carrier wave generator to generate a burst of a powering frequency to power a passive transponder;
a demodulator to demodulate a response data from an RF response from a transponder;
a tuned circuit in electrical communication with said demodulator, said tuned circuit having a selected bandwidth at substantially a communication frequency;
a memory module in electrical communication with the tuned circuit to store a response data;
a circuit to compare an incoming response data with a response data stored in the memory module and to send an instruction to a relay bank based on the comparison; and
a relay bank electronically coupled to the circuit and electronically coupled to a physical switching station.

10. The system of claim 9, wherein the interrogator, the memory module, the circuitry, and the relay module are all housed in a same housing.

11. The system of claim 9, wherein the communication frequency is approximately 134 kHz.

12. The system of claim 9, further including a reset button.

13. The system of claim 9, further including circuitry configured to interface with a computer.

14. The system of claim 9, further including at least one visible indicator to indicate status of the Smart Reader.

15. The system of claim 14, wherein the at least one visible indicator is a light emitting diode (LED).

16. The system of claim 9, further including circuitry to accept wired input.

17. A Smart Reader to control a switching station in a movable conveyance system, comprising:
an RFID interrogator;
a memory module electronically coupled to the RFID interrogator;
a comparator circuit electronically coupled to memory module and the RFID interrogator;
a relay circuit electronically coupled to the comparator circuit; and
a housing
